(19) United States
(12) Patent Application Publication
(10) Pub. No.: US 2008/0101383 A1
(43) Pub. Date: May 1, 2008

(54) Repeater Node for a Network

(76) Inventors: Stephan Lietz, Bad Salzdetfurth (DE); Thomas Eymann, Hildesheim (DE); Karsten Mauler, Vechelde (DE); Christoph Kunze, Sibbesse (DE)

Correspondence Address: KENYON & KENYON LLP, ONE BROADWAY, NEW YORK, NY, 10004, US

(21) Appl. No.: 11/794,069

(22) PCT Filed: Nov. 22, 2005
(86) PCT No.: PCT/EP05/56148

§ 371 Date: Jun. 22, 2007

(30) Foreign Application Priority Data
Dec. 23, 2004 (DE) 102004062034.2

(51) Int. Cl. H04L 12/56

(52) U.S. Cl. 370/400

(57) ABSTRACT

The invention relates to a repeater node for a network having a number of nodes, which repeater node is embodied to acknowledge a reception of data that are addressed by a first of the nodes to a second of the nodes. The network can also have multiple nodes in addition to the repeater node.

### BACKGROUND OF THE INVENTION

1. Field of the Invention

The present invention relates to a repeater node for a network, to a network, to a method for transferring data, to a computer program, and to a computer program product.

2. Description of Related Art

Networks according to the IEEE 1394 standard have a number of nodes. The maximum number of nodes is limited by cable length, transfer speed, and the disposition of the nodes. Within a network of this kind, a serial bus according to the IEEE 1394 standard supports the transfer of asynchronous and isochronous data. Provision is made that a reception of asynchronous data must be acknowledged by a node that receives those data, so as thereby to ensure a secure data transfer. Such an acknowledgment is not necessary for isochronous data.

According to the IEEE 1394B standard agreed to in the year 2002, the following cable types between two nodes, with respective maximum lengths, are specified: UTP5—100 m, POF—50 m, HPCF—100 m, MMF—100 m, and STP—4.5 m. According to this specification, a maximum distance of 100 meters is permissible between two nodes within a network according to the IEEE 1394 standard. Present-day ICs (integrated circuits or physical chips) that are required for implementation of a node according to the IEEE 1394 standard do not allow a greater distance between two such nodes.

### SUMMARY OF THE INVENTION

The repeater node according to the present invention is located in a network that has a number of nodes, and is disposed in particular along a transfer path between two nodes of that network. The repeater node is embodied to acknowledge a reception of data that are addressed by one node of the one side of the network to a second node of the other side of the network.

The repeater node according to the present invention is embodied for, or has the function of, acknowledging data or data packets that are not addressed to it, but instead are addressed by the one node of the network to the other nodes. The data are transferred between the two nodes via the repeater node. In addition to the repeater node, further nodes can be located within the network along the transfer path between the two nodes. An acknowledgment of the reception of asynchronous data between two nodes that are separated by the repeater node in the network is accomplished, however, only by the repeater node. Other nodes whose connecting path does not pass through the repeater node can make available reception acknowledgments for the data that are addressed to them. The repeater node according to the present invention now makes it possible to increase, as compared with conventional networks, a maximum possible distance between two nodes.

In a preferred embodiment of the invention, provision is made that the repeater node is provided for a network designed according to an IEEE 1394 standard, and is embodied to acknowledge the reception of asynchronous data.

A maximum possible distance between two nodes according to the IEEE 1394 standard, in particular the IEEE 1394B standard, is at present 100 meters. Greater distances between such nodes are not possible because of certain maximum signal transit times within the network. Principally affected thereby is a so-called “Boss_Restart_Time”; this time span defines a node's waiting time for a reception acknowledgment for data that were emitted by that node.

The repeater node according to the present invention, in particular if it is designed according to the IEEE 1394 standard, makes possible an elongation of a path for transferring data between two nodes within the network.

Regarding a configuration of the hardware of the repeater node according to the present invention, provision can be made for implementing in it a physical layer having at least two terminals or ports and optionally transceiver modules that are embodied in accordance with a physical line used within the network. In particular, the repeater node according to the present invention has a logic unit for acknowledging a reception of the data or data packets.

A conventional node according to the IEEE 1394 standard in a corresponding network has various functionalities that are distributed over three different layers. Two of these layers—a physical layer and a link layer—are usually realized in terms of hardware by way of one or two ICs (integrated circuits), a so-called physical IC and/or a link IC. All the applications that are operated on a physical line or a bus according to the IEEE 1394 standard normally require at least the physical IC (physical layer controller, PHY) and the link IC (link layer controller, LLC).

In the case of the repeater node according to the present invention it is in particular possible with the logic unit to acknowledge, to a node embodied as transmitter of the data, the reception of the data, even though those data are addressed not to the repeater node but to a different node. This logic unit substantially differentiates the repeater node from the other nodes. The repeater node according to the present invention is thus suitable for all physical media, such as transfer lines or radio links, that are specified in particular according to the IEEE 1394B standard.

With the present invention, an elongation of a transfer path between two nodes according to the IEEE 1394 standard, through the repeater node according to the IEEE 1394 standard, is realized.

The network according to the present invention has a number of nodes, and at least one repeater node that is disposed in particular along a transfer path between two of those nodes. With the at least one repeater node, it is possible to acknowledge a reception of data that are addressed by a first of those nodes to a second of those nodes. The repeater node is located along the transfer path between the two communicating nodes.

In a preferred embodiment, the network according to the present invention is designed according to an IEEE 1394 standard and has the nodes embodied according to that IEEE 1394 standard as well as the at least one repeater node embodied according to that IEEE 1394 standard. This repeater node according to the IEEE 1394 standard has substantially a physical layer, and possesses the particular function, implemented in the logic unit, of acknowledging preferably asynchronous data or data packets, transferable within the network, that are not addressed to it.

A protocol configuration for the transfer of data within the network according to the present invention corresponds to the IEEE 1394 standard and is not manipulated by the repeater node according to the IEEE 1394 standard. A verification of the data within the repeater node according to the present invention is accomplished according to the IEEE 1394 standard or according to a functionality of the physical layer (physical chip) provided in the repeater node. Within the physical layer, a bit-by-bit regeneration of a stream of data transferred within the network is performed. Provision can optionally be made here, by way of an additional function or an additional module, for the repeater node according to the present invention to amplify the data upon forwarding to those nodes to which the data are actually addressed.

The method according to the present invention serves for the transfer of data within a network that has a number of nodes. In this context, data are transmitted from a first of those nodes to a second of those nodes. A reception of these data is acknowledged by at least one repeater node that is, in particular, disposed along the transfer path between those two nodes. A reception of data that are not addressed to the at least one repeater node can be acknowledged by that at least one repeater node.

With this method, a distance between the two nodes within the network can be greatly increased. In the at least one repeater node, data that are addressed not to it, but instead respectively to one of the two nodes, are acknowledged. The data are thus transferable via multiple repeater nodes and thus over a corresponding distance.

In a preferred embodiment of the method according to the present invention, provision is made for data addressed to a node embodied as a receiver to be transmitted from a node embodied as a transmitter to that receiver. A reception of those data is acknowledged by the repeater node by way of a signal directed to the transmitter. A response giving information as to a reception of the data is conveyed to the repeater node from the receiver. Based on that response, a corresponding signal is sent from the repeater node to the transmitter. An acknowledgment of the reception of the data on the part of the repeater node is effected via the so-called “ack_pending” signal that is conveyed to the transmitter. The transmitter is thereby made aware that a further response, a so-called response packet, will follow. With this response packet, the repeater node informs the transmitter via corresponding signals as to whether the data have either arrived at the receiver (“resp_complete”) or not arrived (“resp_error”). This procedure is accomplished with the additional logic unit provided in the repeater node according to the present invention, as soon as the repeater node has received a response from the addressed receiver. With these actions it is possible, with the method according to the present invention for transferring data and the communication method thereby made available, to comply, within a network that is based in particular on the IEEE 1394 standard, with the signal transit times necessary for an exchange of data, and thus to realize the exchange of data over greater distances than were hitherto possible.

The invention can be used, for example, in a digital, audiovisual communication system having a network, in particular according to the IEEE 1394 standard. A network of this kind can have as many as 63 nodes, which are interconnected via transfer paths of different lengths. As many as 1023 of these networks can be interconnected using network bridges according to IEEE 1394.1.

The computer program according to the present invention having program code means is designed to carry out all the steps of the method according to the present invention when that computer program is executed on a computer or a corresponding processing unit, in particular one of the device according to the present invention, such as the repeater node according to the present invention and/or the network according to the present invention.

The computer program product according to the present invention having program code means is provided for carrying out the method according to the present invention when that computer program is executed on a computer or a corresponding processing unit, in particular one of the devices according to the present invention, such as the repeater node according to the present invention and/or the network according to the present invention.

Further advantages and embodiments of the invention are evident from the description and the attached drawings.

It is understood that the features recited above and those yet to be explained below can be used not only in the respective combination indicated, but also in other combinations or in isolation, without leaving the context of the present invention.

### BRIEF DESCRIPTION OF THE DRAWINGS

FIG. 1 schematically depicts a first embodiment of a network according to the present invention having a repeater node according to the present invention.

FIG. 2 schematically depicts a second embodiment of a network according to the present invention having a repeater node according to the present invention.

FIG. 3 schematically depicts a third embodiment of a network according to the present invention having a repeater node according to the present invention.

### DETAILED DESCRIPTION OF THE INVENTION

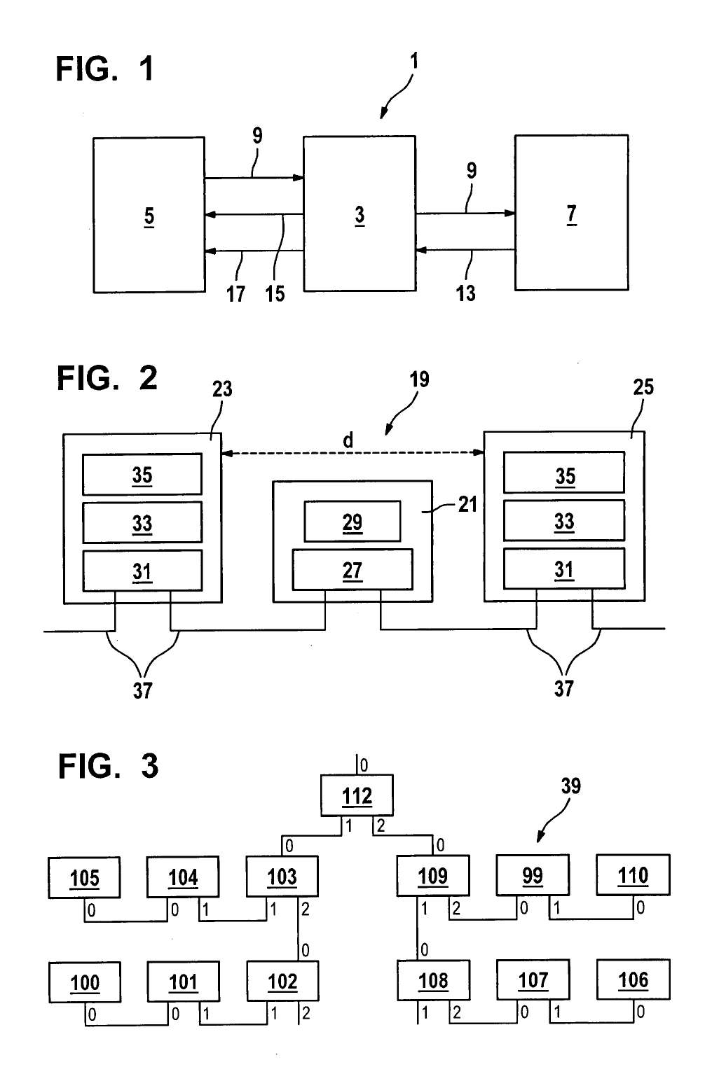

FIG. 1 schematically depicts a first embodiment of a network 1 according to the present invention, for example according to the IEEE 1394 standard, that has two nodes 5, 7 according to the IEEE 1394 standard. A repeater node 3 according to the present invention is disposed along the transfer path of these two nodes 5, 7.

Upon execution of the preferred embodiment of the method according to the present invention, provision is made for first node 5 to make a request to second node 7, or to transmit data 9 addressed to that second node 7. Repeater node 3 is advantageous especially in the context of a transfer of asynchronous data 9 between first node 5 and second node 7. Upon execution of the method according to the present invention, repeater node 3, upon the reception of asynchronous data 9, transmits to first node 5 a so-called “ack_pending” signal 15 acknowledging the request. First node 5 is thereby informed on the part of repeater node 3 that the request is being processed or that data 9 are being transmitted or transferred. At the same time, repeater node 3 forwards data 9 to second node 7 to which data 9 are addressed. As the method continues, second node 7 transmits to repeater node 3 a response (acknowledge) signal 13 giving information as to the reception of data 9. A corresponding acknowledgment of reception is forwarded as a signal 17 (“ack_response”) from repeater node 3 to first node 5. Upon execution of the method, repeater node 3 acknowledges a reception of the data transmitted by first node 5 and addressed to second node 7, which data were, however, not addressed to repeater node 3.

FIG. 2 schematically depicts a second embodiment of a network 19 according to the present invention. This network 19 according to the present invention has a first node 23 and a second node 25. Network 19 and nodes 23, 25 are preferably embodied according to the IEEE 1394 standard. A connection between nodes 23, 25 within network 19 is made available by a cable 37. A repeater node 21 is connected, along a transfer path between the two nodes 23, 25, to those nodes 23, 25 via line 37.

Nodes 23, 25 according to the IEEE 1394 standard possess various functionalities that are distributed over three different layers 31, 33, 35. In terms of hardware, nodes 23, 25 have a physical layer 31 (physical layer controller, PHY) and a link layer (link layer controller, LLC) 33. Applications of these nodes 23, 25 are implemented within third layer 35.

Repeater node 21 according to the present invention is made up on the one hand of a physical layer (physical layer controller, PHY) 27 having at least two outputs, and optionally transceiver modules corresponding to physical line 37 that is used. In contrast to the two conventional nodes 23, 25, repeater node 21 according to the present invention additionally has a logic unit 29 that is designed to make available reception acknowledgments for data.

If provision is made for first node 23 to transmit data to second node 25, a transfer of those data takes place via line 37, those data passing through repeater node 21 disposed in line 37. With the additional logic unit 29, a reception of those data by repeater node 21 is acknowledged to first node 23, even though those data are not addressed to repeater node 21.

With the present invention, it is possible to increase a distance d between two nodes 23, 25 according to the IEEE 1394 standard in network 19 according to the IEEE 1394 standard, as compared with conventional networks according to that standard. A maximum distance between two nodes according to the IEEE 1394 standard in accordance with the existing art is at present 100 meters. Greater distances are not permissible because of maximum signal transit times in the context of data transfer. As a result of repeater node 21 according to the present invention, a waiting time of a node 23, 25 for a reception acknowledgment for a transmitted data packet is within the parameters or limits for maximum signal transit times permissible according to the IEEE 1394 standard, despite a distance d between the two nodes 23, 25 that can now be greater than 100 meters.

Network 39 schematically depicted in FIG. 3 shows nodes 100, 101, 102, 103, 104, 105, 106, 107, 108, 109, 110, 112 interconnected by transfer paths, as well as a repeater node 99 according to the present invention disposed along a transfer path between the two nodes 109, 110. All the nodes 100, 101, 102, 103, 104, 105, 106, 107, 108, 109, 112 can exhibit, within network 39 embodied according to the IEEE 1394 standard, only the maximum distances permissible for that IEEE 1394 standard. Node 110, however, because it is connected via repeater node 99 according to the present invention to the other nodes 100, 101, 102, 103, 104, 105, 106, 107, 108, 109, 112, exhibits a greater distance from those other nodes 100, 101, 102, 103, 104, 105, 106, 107, 108, 109, 112. The insertion of repeater node 99 according to the present invention allows acknowledgment of a reception of data that are exchanged between node 110 and one of the other nodes 100, 101, 102, 103, 104, 105, 106, 107, 108, 109, 112 even though those data are not addressed to repeater node 99.

In addition to a basic functionality of repeater node 99, of acknowledging data (in particular asynchronous data) or requests that are not addressed to it, this repeater node 99 can be equipped with further complex functionalities. In one possible variant realization, provision is made for repeater node 99 to acknowledge a reception of all data, regardless of whether such data or requests are passing along the line branch or bus branch on which repeater node 99 is or is not disposed.

When node 103, for example, sends data to or makes a request of node 110, repeater node 99 transmits a corresponding reception acknowledgment to node 103. When node 103 sends data or a request to node 106, node 103 receives a corresponding acknowledgment both from repeater node 99 and from node 106. In this context, node 106 will process only the acknowledgment received first, and discard an acknowledgment that arrives subsequently. If an “ack_pending” signal acknowledging the reception is the first to arrive at node 103, repeater node 99 will send on to node 103 the “ack_response” signal, corresponding to the acknowledgment from node 106.

A further possible implementation of the invention provides for repeater node 99 to acknowledge only a reception of data or requests, which between nodes 110 and 100, 101, 102, 103, 104, 105, 106, 107, 108, 109, 112, which are separated from one another within network 39 by repeater node 99, actuates. This means that, for example, a transmission of data or a request from node 100 to node 108 is not taken into account by repeater node 99. A transmission of data or a request from node 100 to node 110, on the other hand, is acknowledged by repeater node 99. With this embodiment of the invention, repeater node 99 knows a bus structure (topology map) of network 39. Repeater node 99 can independently create for itself a bus structure of this kind by, for example, addressing all the nodes 100, 101, 102, 103, 104, 105, 106, 107, 108, 109, 110, 112 of network 39 and noting the inputs or ports (0 or 1) of repeater node 99 at which nodes 100, 101, 102, 103, 104, 105, 106, 107, 108, 109, 110, 112 are located. Another possibility would be for it to poll the bus structure from a so-called root node 112 at a central point of network 39, and examine it as to which of nodes 100, 101, 102, 103, 104, 105, 106, 107, 108, 109, 110 are located in the direction of that root node 112, and which of nodes 100, 101, 102, 103, 104, 105, 106, 107, 108, 109, 110 are separated from root node 112 by repeater node 99.

1-14. (canceled)

15. A repeater node for a network having a plurality of nodes, the repeater node being embodied to acknowledge a reception of data that are addressed by a first of the two nodes to a second of the two nodes.

16. The repeater node according to claim 15, which is embodied to acknowledge a reception of data that are not addressed to it.

17. The repeater node according to claim 15, which is disposed along a transfer path between two nodes of the network.

18. The repeater node according to claim 16, which is disposed along a transfer path between two nodes of the network.

19. The repeater node according to claim 15, which is provided for a network designed according to an IEEE 1394 standard and is embodied to acknowledge the reception of asynchronous data.

20. The repeater node according to claim 16, which is provided for a network designed according to an IEEE 1394 standard and is embodied to acknowledge the reception of asynchronous data.

21. The repeater node according to claim 15, wherein a physical layer, having at least two terminals and transceiver modules that are embodied according to a utilized physical line, is implemented, and which has a logic unit for acknowledging a reception of the data.

22. A network having a plurality of nodes and at least one repeater node, wherein a reception of data that are transmitted from a first of the nodes to a second of the nodes and addressed to the second node is acknowledgeable by the at least one repeater node.

23. The network according to claim 22, wherein the repeater node is embodied to acknowledge a reception of data that are not addressed to the at least one repeater node.

24. The network according to claim 22, wherein the at least one repeater node is disposed along a transfer path between the two nodes.

25. The network according to claim 23, wherein the at least one repeater node is disposed along a transfer path between the two nodes.

26. The network according to claim 22, which is designed according to an IEEE 1394 standard and has the nodes embodied according to said IEEE 1394 standard and the at least one repeater node embodied according to this IEEE 1394 standard.

27. The network according to claim 23, which is designed according to an IEEE 1394 standard and has the nodes embodied according to said IEEE 1394 standard and the at least one repeater node embodied according to this IEEE 1394 standard.

28. A method for transferring data within a network having an arbitrary number of nodes, comprising: transmitting data addressed by a first of the nodes to a second of the nodes, and acknowledging a reception of this data by at least one repeater node.

29. The method according to claim 28, wherein a reception of data that are not addressed to the at least one repeater node is acknowledged by the at least one repeater node.

30. The method according to claim 28, wherein data addressed by a node provided as transmitter to a node provided as receiver are transmitted to this receiver; wherein a reception of this data is acknowledged, by the at least one repeater node that is disposed along a transfer path between these two nodes, by way of a signal directed to the transmitter; and wherein at least one repeater node a response giving information as to a reception of the data is transmitted from the receiver, and on the basis of said response a corresponding signal is sent from the at least one repeater node to the transmitter.

31. A computer program having program code means for carrying out the method according to claim 28 when the computer program is executed on a computer or a corresponding processing unit.
